(19) United States
(12) Patent Application Publication
(10) Pub. No.: US 2008/0286071 A1
(43) Pub. Date: Nov. 20, 2008

(54) Fastener with interchangeable decorative elements

(76) Inventor: Jonathan J. A. Potter, Seattle, WA (US)

Correspondence Address: DWC LAW FIRM, P.S., P.O. BOX 3041, SEATTLE, WA, 98114-3041, US

(21) Appl. No.: 11/803,485

(22) Filed: May 15, 2007

(51) Int. Cl. F16B 37/14; B23P 17/00

(52) U.S. Cl. 411/372.6; 29/525.01

(57) ABSTRACT

In some embodiments, a decorative fastener assembly is provided having a fastener with a receiving chamber. A decorative member having a minor shaft is insertable into the receiving chamber for attaching the decorative member to the fastener. The minor shaft can be threaded.

### BACKGROUND

1. Field of the Invention

The present invention relates to fasteners for use in coupling work-pieces, and more specifically, to fasteners such as screws having interchangeable decorative elements that can be selectively attached to the fasteners.

2. Description of Related Art

U.S. Pat. No. 5,513,935 to Sharber, et al., describes a decorative cover for the head of a nail, or other similar fasteners. The cover is attached to the fastener prior to its use. That is, the fastener head is fitted into a slot of the cover before the fastener is applied to a workpiece. This can be limiting in that after the fastener is applied, the cover cannot be changed. Also, if the fastener is a nail, the cover may be damaged during pounding, since it must be attached before using the fasteners.

U.S. Pat. No. 3,122,051 to Greene, describes decorative covers for the heads of fasteners. The decorative covers include flanges that snap into place around the edges of the fastener heads. After application, the covers are not removable, or at the very least, are difficult to remove.

U.S. Pat. No. 4,601,624 to Hill, describes a “Fastener Head Cover Assembly” comprised of multiple parts. The assembly includes an anchor member that fits below the fastener head, and a cover plate that fits over the fastener head. The anchor member must be applied before the fastener is applied to a work piece, as it needs to fit below the fastener head. Also, the anchor member has petal-like grippers that extend outward from the anchor, intended to snap-fit to the cover plate that is placed over the fastener head. Again, after application, it is inconvenient, if even possible, to remove the cover plate. Also, the dual part cover assembly could be cumbersome in some circumstances.

U.S. Pat. No. 2,363,665 to H. F. George describes a “Screw Cap” comprised of projections that extend below the screw cap that can be forced into the slots (or grooves) on a screw head to secure the screw caps to screws. The projections are “sufficiently distorted” when forced into the screw head slots to “grip the walls” of the slots, thereby rendering them irremovable for practical purposes, and not reusable.

These references demonstrate some of the available options for use in decorating a fastener. There is a need for an improved way to provide decorative aspects to fasteners.

### BRIEF DESCRIPTION OF THE DRAWINGS

FIG. 1a is a perspective view of an embodiment of the present invention showing a screw-type fastener with a first interchangeable decorative element.

FIG. 1b is a perspective view of the embodiment of the present invention shown in FIG. 1a, but showing the decorative element being coupled to the screw-type fastener and snugly fitted thereon.

FIG. 2 is an elevation partial cutaway side view of the screw-type fastener of FIG. 1, further showing a second interchangeable decorative element, as viewed from line FIG. 2a of FIG. 1.

FIG. 3 is a plan view of the surface of the head of the screw-type fastener of FIG. 2 as viewed from line FIG. 3-FIG. 3, in FIG. 2.

FIG. 4a is a partial cut-away view of a decorative element and fastener for some embodiments of the present invention wherein the decorative element is attachable by magnetic attachment to the fastener head.

FIG. 4b is plan view of the embodiment of the invention shown in FIG. 4a.

### BRIEF SUMMARY OF THE INVENTION

Some embodiments of the present invention include a fastener that has a main shaft for use in attaching work-pieces together. The main shaft can be threaded. A head portion can be provided above the main shaft, and the head portion can have a receiving chamber. A decorative member having a minor shaft attached thereto can be removably attached to the head portion of the fastener, by screwing the minor shaft into the receiving chamber.

### DETAILED DESCRIPTION

In the following description, certain specific details are set forth in order to provide a thorough understanding of various embodiments of the invention. However, upon reviewing this disclosure, one skilled in the art will understand that the invention may be practiced without many of these details. In other instances, well-known structures and materials of construction associated with certain fastener types and magnets have not been described in detail to avoid unnecessarily obscuring the descriptions of the embodiments of the invention.

Various embodiments of the present invention are described in the context of screw-type fasteners for use in attaching work pieces. However, as those skilled in the art will appreciate after reviewing this disclosure, fasteners of different structures are contemplated also, such as nail-type fasteners. The applications described and illustrated herein are not intended to be limiting and are provided for illustrative purposes.

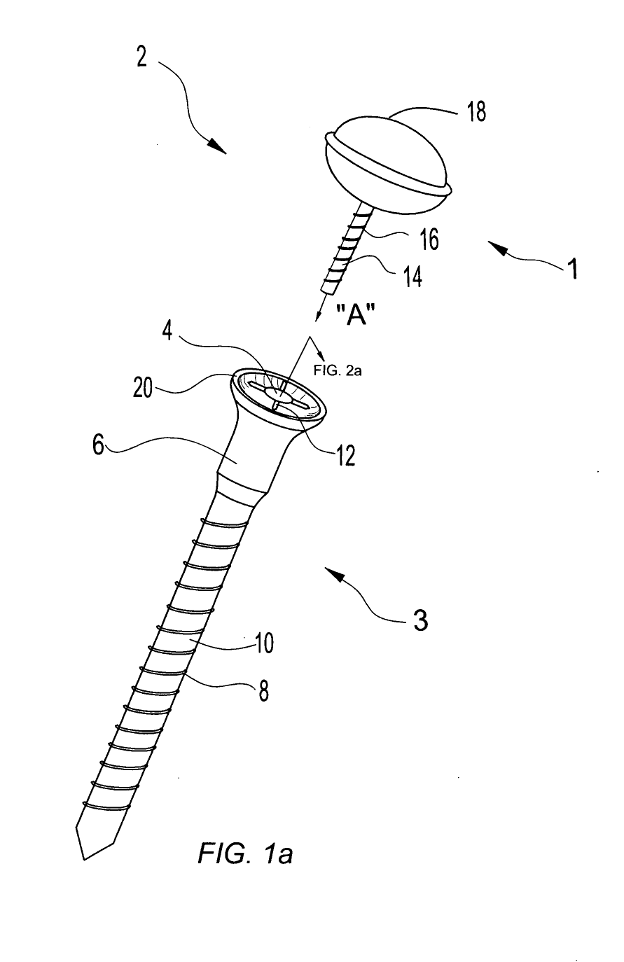

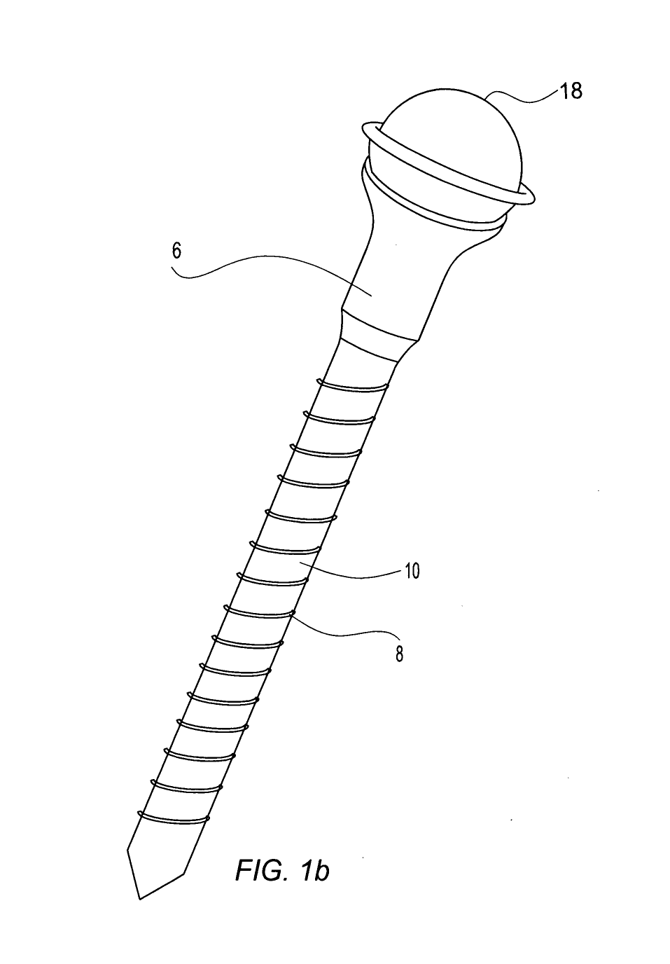

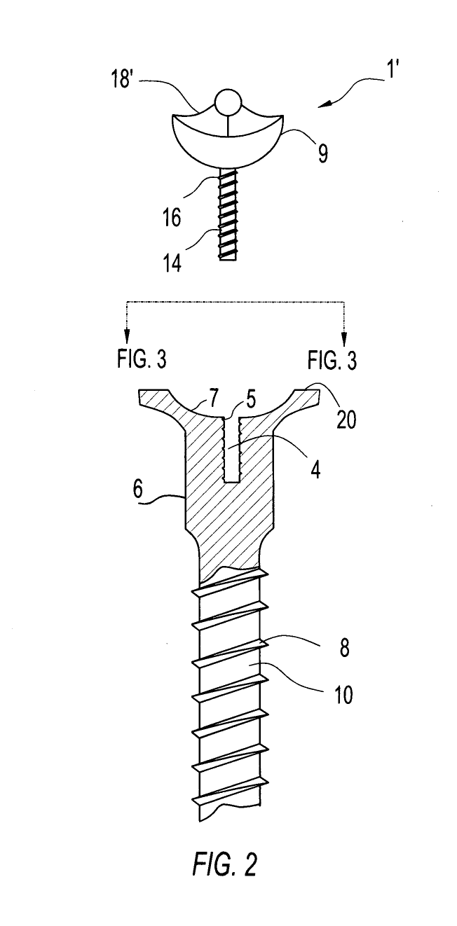

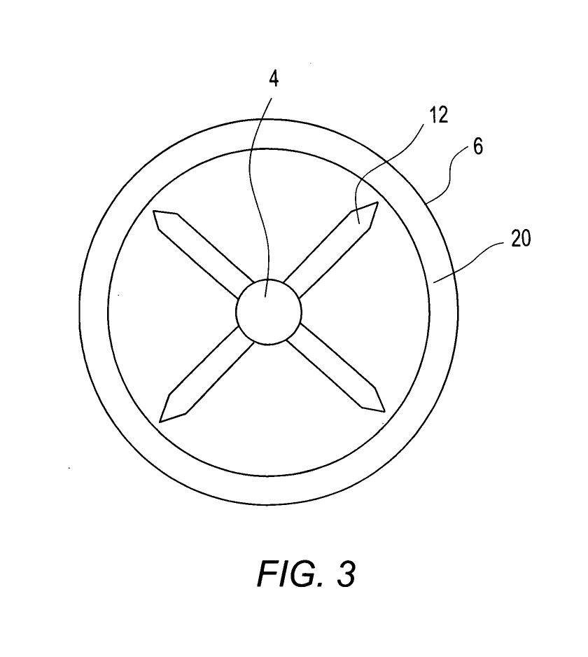

As can be seen in FIG. 1a, some embodiments of the present invention comprise an assembly 2 including a screw-type fastener 3 having a head portion 6 and shaft 10 with threads 8 provided along the shaft portions. The head portion 6 has slots 12 formed thereon. The slots 12 are accessible on a top surface 20 of the head portion 6, which can also be seen in FIG. 3. The top surface 20 can include a concave surface portion 7 (See, FIG. 2). The slots 12 can be configured to be mated with the tip of a screwdriver or other device for applying torque to the screw-type fastener 3 for rotating it when it is inserted into a work-piece, thereby driving the shaft 10 into the work-piece, and normally into another work-piece (or another portion of the work-piece) for fastening the work-pieces, or work-piece portions together.

The assembly 2 can also include a first decorative element 1, as shown in FIG. 1a. The first decorative element 1 includes a decorative member 18. The decorative member 18 can be any of a variety of shapes and decorative features, as will be appreciated by those skilled in the art after reviewing this disclosure. The illustrated decorative members are not intended to be limiting. The first decorative element 1 can also include a shaft 14 with screw-type threads 16 formed thereon, for use in attaching the first decorative element 1 to the screw-type fastener 3. Referring to FIG. 2, the screw-type fastener 3 can have a receiving chamber 4 with an internal surface 5. The internal surface can have a surface contour designed to mate with the shaft 14 of the decorative element. For example, the internal surface 5 can include a helix pattern formed thereon for use in mating with the threads 16 of the shaft 14. The receiving chamber 4 can be formed in a center portion of the screw head 6, as best seen in FIGS. 1a & 2, with an opening of the receiving chamber being centered on the top surface 20 of the screw head 6.

As mentioned previously, the top surface 20 of the screw head 6 can be provided with a concave holding surface 7, as best seen in FIGS. 1a and 2. The concave holding surface 7 can allow a bottom portion 9 of the decorative member 18 to rest below a high portion of the top surface 20 of the screw head 6, to fit snugly therein as shown in FIG. 1b.

Thus, some embodiments of the present invention comprise a fastener assembly 2 having a plurality of decorative elements 1, with the decorative elements having different decorative members 18 (e.g., a second decorative element 1′ is shown in FIG. 2). The decorative elements 1 can be interchangeable with other decorative elements having the same decorative portion 18 as the first decorative element 1, or different decorative portions 18′ so that a user can select different looks for the fastener assembly 2. In some embodiments of the present invention, the assembly 2 can be provided as a unit to users, with any number of screw-type fasteners 3 being provided in the package, and with a plurality of different decorative elements have different decorative members. In other embodiments of the present invention, the screw-type fasteners 3 are provided separately from one or more of the decorative elements.

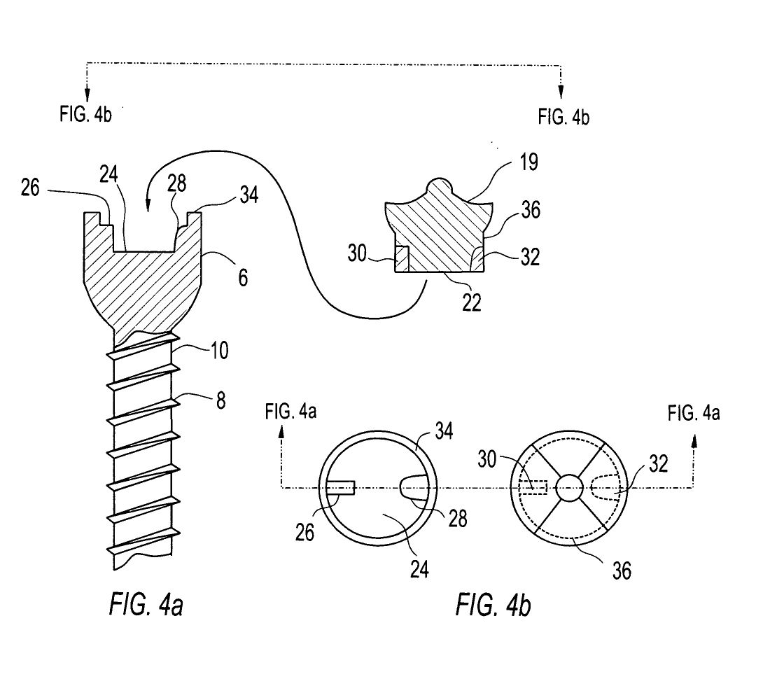

Referring now to FIG. 4a, in other embodiments of the present invention, a decorative element 40 is attachable to a fastener 42 by a magnetic field, such as by providing a permanent magnet at a bottom 22 of the decorative element 40 or at a receiving surface 24 of the fastener head 6′. The fastener head 6′ can have an annular wall 34 within which a base portion 36 of the decorative element 40 can rest when the decorative element 40 is attached to the fastener head 6′, to allow the bottom 22 of the decorative element 40 to attach to the receiving surface 24. In such embodiments, the base portion 36, of the decorative element 40 can also be provided with notches 30, 32 that mate with corresponding protrusions 26, 28 on the fastener head 6′, as best seen in FIGS. 4a and 4b. In some embodiments, there can be two notches 30, 32 with different interior contours, and two corresponding protrusions 26, 28 configured to fit within the notches, which can aid in aligning the orientation of the decorative element 40 on the fastener head 6′, as will be appreciated by those skilled in the art after reviewing this disclosure. Different decorative elements 40 having different decorative members 19 can thus be selectively attached to the fastener head 6′ by a user. The fastener 42 can be a screw-type fastener or other type of fastener.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described apparatus and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A decorative fastener comprising:
a main shaft for use in attaching work-pieces together;
a head portion attached to the main shaft, the head portion having a receiving chamber; and
a decorative member, the decorative member having a minor shaft attached thereto that is configured to mate with the receiving chamber of the head portion.

2. The decorative fastener of claim 1 wherein the main shaft is threaded.

3. The decorative fastener of claim 1 wherein the minor shaft is threaded.

4. The decorative fastener of claim 1 wherein there are a plurality of decorative members, each decorative member have a different shape or different decorative feature such that a user can interchangeably attach different decorative members onto the head portion for different decorative effects.

5. The decorative fastener of claim 1 further comprising a concave holding surface formed on the head portion.

6. The decorative fastener of claim of claim 5 wherein an opening for the receiving chamber is disposed on the concave holding surface.

7. The decorative fastener of claim 5 wherein there are a plurality of interchangeable decorative members, each being configured to mate with the concave holding surface.

8. A decorative fastener assembly comprising:
at least one fastener having a head and a main shaft; and
a plurality of decorative members, each having different decorative features and each being removably connectable to the head of the at least one fastener.

9. The decorative fastener assembly of claim 8 wherein the head has a receiving chamber or receiving surface configured to mate with a mating member attached to each of the decorative members.

10. The decorative fastener assembly of claim 8 wherein the head has a receiving chamber, and wherein the decorative member has a minor shaft that is threaded.

11. The decorative fastener assembly of claim 10 wherein the main shaft and minor shaft are each threaded.

12. The decorative fastener assembly of claim 8 wherein each of the decorative members is attachable to the head by a magnet.

13. The decorative fastener assembly of claim 8 wherein the head has a concave holding surface formed thereon which can mate with each of the plurality of decorative members.

14. The decorative fastener assembly of claim 13 wherein a receiving chamber for use in receiving a minor shaft attached to each of the decorative members, has an opening disposed on the concave holding surface.

15. A method of attaching decorative members to a fastener comprising:
providing a fastener having a head and receiving chamber disposed on the head;
providing a decorative member having a shaft attached thereto, the shaft being insertable within the receiving chamber for removably and securely attaching the decorative member to the head of the fastener.

16. The method of claim 15 wherein the shaft is threaded.

17. The method of claim 15 further comprising a plurality of decorative members, each having different decorative features, and each being removably and securely attachable to the head of the fastener.

18. The method of claim 15 wherein the head of the fastener has a concave surface configured to mate with a bottom portion of the decorative member.
